(19) United States
(12) Patent Application Publication
(10) Pub. No.: US 2012/0034135 A1
(43) Pub. Date: Feb. 9, 2012

(54) PLASMA REACTOR

(75) Inventor: Philip John Risby, Norwich Norfolk (GB)

(73) Assignee: GASPLAS AS, Kjeller (NO)

(21) Appl. No.: 13/202,459

(22) PCT Filed: Feb. 19, 2010
(86) PCT No.: PCT/GB10/50290

§ 371 Date: Oct. 26, 2011

(30) Foreign Application Priority Data
Feb. 19, 2009 (GB) 0902784.8

(51) Int. Cl. B01J 19/12

(52) U.S. Cl. 422/186.03

(57) ABSTRACT

A reaction vessel has a reaction chamber, and two or more plasma nozzles coupled to the reactor chamber. Each plasma nozzle has a microwave plasma generator powered by a magnetron, and a feed tube for directing a flow of material via the plasma generator to a respective inlet to the reaction chamber whereby the plasma generator at least partly ionises the material to form a plasma prior to entry of the at least partly ionised material into the reaction chamber. The plasma-generating region of each nozzle is separated from the reactor chamber at a distance between 0.005 to 1 m.

This invention relates to the field of plasma reactors. In particular, but not exclusively, this invention relates to a reactor for microwave-generated plasma that may be used for the processing of a wide variety of feed materials at commercial scales.

With the current focus on reducing harmful emissions from cars and other vehicles and buildings there has been much research into developing vehicles that are fuelled by alternatives to petrol and oil such as hydrogen and biogas. Whilst the adoption of alternatives to hydrocarbon fuels offers the opportunity for a more environmentally-friendly vehicle, the process by which such alternative fuels are produced remains far from ideal. Hydrogen for example is currently synthesised by the catalytic cracking of hydrocarbon molecules. The high temperatures required for this reaction to take place are achieved usually by burning oil or coal, resulting in the emission of further environmental pollutants. In fact, current commercial hydrogen production processes are considered to generate a higher volume of harmful greenhouse gases per useful energy quota of hydrogen than direct combustion of the fuel that the hydrogen is intended to replace. In other words, currently hydrogen is not a clean fuel when its production is taken into account.

Therefore, there is a need to develop a process capable of producing hydrogen with high efficiency and significantly lower environmental impact than is currently available. Ideally such a process would be highly flexible in that it should readily admit to operation on small, medium and large commercial scale. One method that offers the potential to generate hydrogen at lower environmental costs than existing commercial systems utilises plasma processing. In plasma processing, gases or liquids are input to a chamber in which they are ionised to form a plasma, for example by exposure to a high intensity field. In the plasma state the constituents of the feed material are dissociated and may either be extracted separately, recombined or reacted with additional feed materials, depending on the required output product. Plasma processing also offers significant advantages and unique capabilities in, for example, the areas of cracking, dissociation and deposition (including diamond deposition and fabrication of activated products) as well as gas polishing.

Various forms of plasma are known to exist, generally categorised by their energy characteristics: principally thermal plasmas and non-equilibrium plasmas. This latter group include those produced by RF, induction, barrier discharge, microwave and laser excitation. Electromagnetic-induced plasmas, in particular, offer the potential for highly efficient cracking of both gas and liquid feed materials. Such plasmas have been shown to have a catalytic effect, as a result of coupling between the electromagnetic, particularly microwave, field and the feed material, that increases the rate of reaction, which in turn reduces the time for which the feed material must be maintained in the plasma state.

Microwaves are generally taken to refer to electromagnetic radiation with wavelength in the range 1 m to 1×10⁻² m. Electromagnetic radiation outside this range can still generate plasma effectively but microwave sources represent a mature technology as they have long been used in the fields of radar and microwave ovens. Hence microwave sources of suitable power levels are readily available.

There is however a problem in scaling up reaction chambers that use microwave-generated plasmas for commercial operation. Thus, whilst microwave plasmas offer an ideal route to facilitating chemical reactions and processes these have, to date, only been carried out on a relatively small scale and only as a batch process.

Microwave-generated plasma sources can be divided into two groups: those that operate at low pressure and those that operate at around atmospheric pressure and above. Any commercial system that can be used for fuel dissociation is preferably based on a ‘high-pressure’ system, which permits higher throughput of feed fluids and allows effective and energy-efficient storage of end products. The considerable differences in pressure that can occur in a low-pressure system make the adoption of a low-pressure system less attractive for commercial applications.

Two prior types of atmospheric plasma generator are known: low volume single tube and higher volume single magnetron. Whilst reactors based on both types have had some success on the laboratory scale, no design has yet proved sufficiently flexible for operation on a commercial scale. Those in the former group are limited in size by the dimensions of the waveguide required to contain the exciting radiation. That is, the waveguide forms at the surface of the plasma, thereby containing it. A fundamental limit in reactor tube diameter is thus set by the frequency of the microwave source, which limits application to lab-scale devices. Those in the latter group rely on a resonator cavity to generate localised regions of high-intensity electromagnetic fields, which in turn generate and sustain the plasma. High power sources are therefore required, both to generate the plasma and to supply sufficient energy to the feed material for processing. Device size is again limited by microwave source frequency and power as the reaction chamber is required to be resonant. Both microwave frequency and the power at which it is generated therefore limit the potential chamber size of a reactor based on this operational principle.

Whist it is relatively straightforward to combine AC, DC, RF and HF plasmas to generate more plasma for processing, this has not hitherto proved possible to any significant extent with microwave plasmas. The difficulties associated with phase-locking microwave sources to increase the plasma volume in a reactor chamber are well known and well documented. There are a number of technologies for RF electromagnetic energy generation that can be frequency and phase controlled. In order to provide the necessary phase locking for multiple plasma sources to combine additively, RF generators can be fine-tuned to ensure that they all operate at the same phase and frequency. Microwave generators such as a magnetron or Klystron do not have readily-adjustable phase and frequency characteristics. The power, frequency, phase and size of the resonator are all interrelated and it is simply not possible to adjust one without adversely affecting the contribution of another. Moreover, magnetrons and Klystrons emit in a frequency band about a fundamental value. Significant components exist outside the fundamental frequency and these can be magnified enough to feed back into and damage the microwave source. Isolators may be used to protect the source but together phase locking and isolators add considerable cost and reduce the available microwave energy. Practically, magnetron phase-locking has been achieved but only for very few sources, under very limited conditions and with considerable complexity.

One example of a device for the production of a microwave plasma using microwaves is described in U.S. Pat. No. 6,204,603. This device makes use of a coaxial resonator into which microwaves are coupled. An electromagnetic standing-wave pattern is established in the resonator, which, at regions of high-intensity (amplitude), is sufficient to generate the plasma. However, the use of a resonant chamber in this device limits the potential volume of plasma that can be generated at one time.

A large area plasma generator is described in JP2006/156100. This document describes the use of a number of individual microwave antennas to generate plasma within a common space in order to achieve a more uniform distribution of plasma within that space. Although the antennas are separate, they are driven by a single, common microwave source to ensure all of the plasma sources (antennas) are in phase, thereby also limiting the maximum plasma volume. The document clearly illustrates the difficulties and complexities involved in maintaining a plasma region using multiple microwave plasma sources.

It is an object of this invention to provide an alternative device for plasma utilisation employing microwave electromagnetic radiation.

It is a further object of the present invention to provide a plasma generating device that is not subject to the same restrictions to the volume of microwave-generated plasma that can be generated and maintained simultaneously to which prior art devices are subject.

A still further object of the present invention is to provide a microwave plasma generator in which the volume and/or power of plasma produced has reduced dependence on the characteristics of the source used in its generation in comparison to conventional plasma reactors.

Accordingly, the present invention provides a reaction vessel comprising a reaction chamber and two or more plasma nozzles coupled thereto, each plasma nozzle comprising a microwave plasma generator and a feed tube for directing a flow of material via the plasma generator to a respective inlet to the reaction chamber whereby the plasma generator at least partly ionises the material to form a plasma prior to entry of the at least partly ionised material into the reaction chamber.

A device constructed in accordance with this invention has numerous advantages over the prior art. Most importantly, with the present invention higher volumes of microwave-generated plasma may be generated and collected simultaneously in a single volume, in comparison to conventional plasma generation, which makes the device and the plasma generation method particularly suited to commercial scale processing operations and enables improved efficiencies to be achieved in plasma processing operations, such as in the production of hydrogen. This set-up allows electromagnetic isolation of the plasma generators from each another, which in turn ensures that their risk of damage by mutual interference is markedly reduced. The plasma generated by such sources is additive as it collects in the reaction chamber. This is achieved without the need for phase locking, which proved a severe limiting factor to the prior art.

A device constructed in accordance with this invention is considerably more flexible than plasma reactors known in the prior art as a result of the reaction chamber being spatially separate from the plasma source. The same reactor can be readily adapted to suit different processes, which may be run continuously if desired.

As stated previously, the accepted range for microwave radiation is wavelengths in the range 1 m to 1×10⁻² m. It is preferred that microwaves used to generate plasma in accordance with this invention are in the range 0.5 m to 0.05 m. The location of the reaction chamber remote from the plasma generator allows multiple plasma-generating sources to be used in which their output is sustained by a mechanism which permits them to be additive. That is, the volume of plasma produced, and hence available for reaction, increases substantially linearly with respect to the number of sources. This is in direct contrast to the prior art in which a fundamental limitation is provided by the characteristics of the generating microwave radiation itself: with conventional plasma reactors, the chamber must be resonant to this radiation or it must generate a waveguide limited region around the plasma, the waveguide function in turn limiting the size to one that is dictated by microwave frequency.

Scaling up prior art processes for microwave plasma generation, such as those described in U.S. Pat. No. 6,204,603 and JP2006/156100, to a commercial scale is not known to have been achieved and is simply not feasible with available technology. Single-tube processes are restricted to low volume because of the need to form a waveguide at the surface of the plasma. It is not feasible to generate more plasma using such a process by extending it to multiple microwave sources. The sources would need to be synchronised in frequency and phase, which is difficult to achieve but, more fundamentally, the volume of plasma would still limited by the dimensions of the waveguide: multiple sources would result in a more intense plasma for more energy-intensive processing but not more processing plasma per se. Single-magnetron processes, as described in U.S. Pat. No. 6,204,603, rely on the reaction chamber being resonant with respect to a suitable mode of the microwave radiation. In this way localised regions of high-intensity fields can be produced within the chamber, which are sufficient to excite and sustain the plasma on timescales sufficient to allow a desired reaction to take place. The requirement for the chamber to be resonant to one of a limited number of modes necessarily means that its size is dictated by the frequency of the microwave source. It is accordingly impossible to scale such a device up and down for a given excitation frequency.

As mentioned above the plasma-generating region is remote from the reaction chamber. The minimum separating distance between a plasma-generating region and the reaction chamber is the minimum distance necessary to ensure electromagnetic isolation of the individual microwave fields of the plasma nozzles. The maximum separating distance is dependent upon the persistence of the plasma state which, in turn, is dependent upon at least the energy of the plasma, and the velocity and stabilisation of the feed flow. Preferably, the separating distance is between 0.005 m and 1 m, more preferably between 0.05 m and 0.5 m, more preferably still between 0.02 m and 0.2 m. The minimum separation is partially dependent upon the wavelength of electromagnetic radiation employed.

Ideally, the plasma generated in accordance with this invention is induced to flow in a stabilising pattern, which extends its existence beyond the plasma generation sites and so enables collection of the plasma in the reaction chamber. The fluid flow within the reaction chamber also enables delineation of a ‘reaction zone’ within the chamber within which the majority of the required reactions take place. Predominantly, it is the plasma afterglow that persists in the collection chamber, the afterglow being that region in which plasma is sustained by mechanisms other than the generating excitation. Such persistence is believed to be assisted by the stabilising flow.

With the plasma sources remote from a common chamber and by transferring and combining plasma plumes in the common chamber in which reactions can take place, with the reactant(s) persisting in a plasma state, this invention offers huge flexibility in fundamental aspects of plasma processing. In particular, the dissociation stage of the plasma process occurs at a location that is physically separate from the recombination stage of the reaction process and isolated from the environment in which dissociation occurs. This allows different process conditions to be established for each stage. This, in turn, permits ideal conditions for recombination to be set in the reaction chamber in order to encourage the desired reaction/recombination. Flexibility is therefore offered both in the potential for scaling up and down the size and output of the reactor vessel and in the type and range of chemical and physical reaction processes that can be performed in the reaction chamber. As will be discussed below in relation to particular embodiments of the invention such a vessel will readily find application in the fields of, among many others, manufacturing, energy production and waste treatment.

Unlike prior art plasma chambers that combine multiple phase-locked microwave plasma generators, with the present invention there is no restriction on the number of microwave plasma generators that may be coupled to the one collection chamber in excess of two. The only practical limit is that of the size of the collection chamber and the physical dimensions of the coupling of a plasma nozzle to the collection chamber i.e. the number of plasma nozzles that can be physically fitted around the chamber. In some applications the number of plasma nozzles may be limited by the need to establish particular gas flow characteristics within the reaction chamber. With the particular embodiments described herein preferably at least 4 plasma generators are coupled to a single reactor chamber.

The total plasma generation inputted to the collection chamber can be from 1 KW to several MW depending upon the application and is a function of the number of plasma nozzles used.

The term “plasma nozzle” should be understood herein to encompass any device that is capable of directing feed fluids from an input port through a plasma-generating region or zone to an output port.

The plasma nozzle may be adapted to encourage stabilising flow in the collection chamber by defining a guidance tube therein. For example, the design of the nozzle may be based on a vortex tube in which lateral inputs lead to an output gas flow with a strong vortex motion. Alternatively, the nozzles may include an agitating element within the tube, for example, a spiral impeller or fan.

Ideally, the nozzle adaptation to encourage stabilising flow is located upstream of the plasma generator. This arrangement has the added advantage of increasing the exposure of the feed material to the plasma zone which, in turn, leads to more uniformity in processing.

The stabilising flow is most preferably a vortex flow, by which it is meant that the gases undergo a generally helical flow, of decreasing radius. It is known that vortex flow can stabilise a plasma to some degree, but it has not hitherto been appreciated that such stabilising mechanism can have the surprising benefits of flexibility in the design of reaction vessels, as described herein.

Alternatively, or in addition, the plasma reactor of the present invention may be further adapted to encourage an additional stabilising flow inside the collection chamber. This additional stabilising flow may be encouraged by the flow characteristics of the stabilising flow in the nozzles and/or by means of the arrangement of plasma nozzles around the collection chamber and/or their manner of coupling to the chamber. The nozzles may be coupled to the chamber so as to input feed materials/plasma to the chamber at an angle to the chamber walls, preferably a tangential angle. The additional stabilising flow may also be a vortex flow. Alternative flow inducers, separate from the nozzles, are also envisaged such as an agitating element within the reaction chamber.

Preferably, the reaction chamber has curved side walls. For example, the chamber may be cylindrical, toroidal or even spherical in shape. This, in combination with the stabilising flow, has great potential for improvement across a huge range of chemical and physical processes. In the first instance, the plasma plumes/afterglow will extend out of the nozzle outlet into the reaction chamber and be shaped by the flow pattern to extend laterally alongside the reaction chamber wall. Feed or other reactant materials that flow around the chamber will then have an increased residency time in an afterglow environment, as the afterglow from successive nozzles is encountered. This allows more complete plasma processing and therefore improved reaction efficiency. If the plasma nozzles are sufficiently close and/or the plumes persist for sufficient time, these individual plumes may merge to form a continuous plasma torus within the chamber.

Another advantage provided by the flow conditions within the chamber is that ready separation of reaction products may, in many cases, be enabled.

For example, if carbon and hydrogen are the reaction products, the carbon may be allowed to cluster and drop under gravity whereas the hydrogen flow may be directed upwards. Exits at or near the top and bottom of the chamber therefore allow these products to be removed as the plasma generation and the reaction in the reaction vessel continues. That is, product removal is facilitated without stopping the reaction process. The potential for continuous running significantly improves productivity.

In another embodiment, the stabilising flow may be capable of supporting a belt of fine particles in suspension within the chamber. These particles may then act as a substrate for one or more of the reaction products, which assists in their separation and removal from the chamber. Again, this permits continuous operation of the reaction vessel as opposed to a batch process, which was hitherto the only means of operation of such reaction vessels.

The reaction vessel or collection chamber of the present invention is not limited by the type of plasma that is used. Each plasma nozzle may comprise a low-volume source or a large-volume resonant source, or indeed any other suitable microwave plasma source. Indeed, in addition to the microwave plasma sources the reaction vessel may have other non-microwave plasma sources and plasma nozzles. It is considered beneficial, for likely commercial applications however, to operate at atmospheric pressure and above. A preferred operating range is 0.3-3 bar, although operating pressures up to around 10 bar can be envisaged.

Specifically, with the present invention the plasma source of each nozzle is preferably derived using a magnetron as the microwave source. Each nozzle comprises a feed tube through which feed materials flow and each magnetron may comprise at least one waveguide dimensioned for microwave radiation and arranged to intersect the feed tube at or near a position at which the electric field of the microwave radiation is most intense. Such a design is simple to implement and, in fact, such microwave sources are readily and cheaply available.

In the preferred embodiment of this invention the feed tube includes a swirl inducer located at or near the intersection of the feed tube with the magnetron waveguide. This ensures that the stabilising (preferably vortex) flow is induced prior to plasma generation which ensures better mixing of the feed materials with the plasma, which in turn ensures better processing.

As stated previously, the accepted range for microwave radiation is wavelengths in the range 1 m to 1×10⁻² m. Using current, easily available devices it is preferred that microwaves used to generate plasma in accordance with this invention have device wavelengths in the range 0.5 m to 0.05 m.

The microwave plasma generator employed in the plasma nozzle is preferably a coaxial magnetron. The energy supplied to the microwave generator of each plasma nozzle is preferably between 0.1 kW and 500 kW, more preferably 0.5 kW to 120 kW, most preferably 1 kW to 75 kW.

In a preferred embodiment all of the plasma nozzles of the plasma reactor each has a microwave plasma generator. However, it is also envisaged that the plasma reactor may comprise a range of different plasma sources connected to the collection chamber some of which may not be microwave plasma generators. It is most preferred that none of the microwave plasma generators of the plasma reactor are phase locked but more generally no more than a minority of the microwave plasma generators connected to a common reaction chamber may be phase locked.

The flow of material through the plasma nozzle preferably includes a fluid, more preferably a gas. Furthermore, the flow through the plasma-generating zone of the plasma nozzle preferentially contains one or more reactants. Depending upon the process reaction, preferably a major part, or ideally all, of at least one of the reactants flows through the plasma-generating zone. The reactants may constitute more than 50% of the flow through the plasma-generating zone, more preferably more than 75% of the flow and most preferably more than 90% of the flow.

The fluid fed to the plasma nozzle is preferably at a temperature of between −20° C. and +600 ° C., more preferably 0° C. to 200° C., most preferably 50° C. to 150° C.

The pressure within the plasma nozzle is preferably between 0.01 bar abs. to 5 bar abs., more preferably 0.3 bar abs. to 2 bar abs., most preferably 0.8 bar abs. to 1.5 bar abs.

The average residence time within the plasma nozzle may be 10⁻⁶ seconds to 10⁻¹ seconds, but preferably ×10⁻⁶ seconds to 10⁻² seconds. It will be understood though that the average residence time is dependent upon the material being ionised. As an example, the specific energy consumed to completely crack methane passing through the microwave plasma generator of the present invention at 100% efficiency is around 23 kJ/mol.

Whilst the volume of the reactor chamber in each case will be dependent upon the intended application and the processing requirements of the plasma reactor, in the case of a 2.45 GHz microwave plasma generator exemplary ranges of volumes are 10⁻³m³ to 10³m³, more preferably 10⁻² m³ to 10² m³, most preferably 1.5 m³ to 10² m³. The volume of the reaction chamber should be no less than 5×10⁴ m³ per nozzle per KW but may extend upwards from this without limitation.

The residency time within the reaction chamber is dependent upon the reaction(s) occurring within the chamber and the desired output product but may extend from 0.1 seconds to several hours.

The reaction chamber (otherwise referred to herein as the collection chamber) ideally includes an exit channel that extends through an upper wall of the chamber, and which is preferably centrally located. The exit channel may extend a pre-selected or adjustable length into the chamber. The exit channel acts as a collection point for gaseous output(s) from the reaction chamber. Its height within the chamber can be adjusted to collect a particular gas product. Also, within the exit channel a number of smaller tubes may be fitted internally in such a manner as to encourage the vortex motion to remain in the reaction chamber and not to dissipate with exhaust gas outflow.

The provision of one or more exits from the reaction chamber enables the reaction products to be extracted without stopping or interfering with plasma generation. That is, without affecting the continuous running of the process. Product removal is also desirable to prevent it clogging up the system (for example, in a carbon-generation process) or to release a build-up of pressure (for example in a hydrogen or other gas-production process).

The plasma reactor may further include a secondary chamber in fluid communication with the reaction chamber. The secondary chamber may also include an exit port. In a preferred embodiment the secondary chamber is located below the reaction chamber. Such a lower port is ideally placed for extracting solid products from the chamber. Moreover, a secondary vortex may be drawn through this exit port, oriented centrally within the chamber, in order to entrain a reaction product for collection. For example, in the cracking of methane in the presence of steam, the output products will be hydrogen and carbon monoxide (syngas). By entraining a flow of magnesium hydride through the central zone of the chamber, the hydrogen will be absorbed by the magnesium hydride for exiting at one port, allowing the carbon monoxide to exit as a gas via the upper exit port. In order to prevent gas escaping the lower exit port, the port may be fitted with a gas-restricting valve.

A collection aid such as an electrostatic collector, powder precipitator or polymer-forming substrate may be included within or in fluid communication with either or both of the upper and lower chambers. These provide further possible means to collect an output product depending upon the nature of the reaction taking place within the reaction chamber. For example, an electrostatic plate or ring will attract solids, encouraging their separation from a gas flow.

A particularly promising application of the present invention is the cracking of hydrocarbons to produce hydrogen gas and carbon. The hydrogen gas can be collected via the exit channel for use as a clean fuel. The carbon can be collected in the form of active carbon.

So as to enable the introduction of substrates or other materials for product collection, the reaction chamber may further include an input channel along which a secondary flow may be passed. Alternatively, other materials may be input into the reaction chamber via one or more of the plasma nozzles which may or may not be actively generating plasma at that time.

The plasma reactor may also include one or more atomising or vaporising devices to enable liquids to be processed in this invention. The atomising or vaporising devices may be located at a plasma nozzle or at an inlet to the reaction chamber

Embodiments of the invention will now be described by way of example only and with reference to the accompanying drawings.

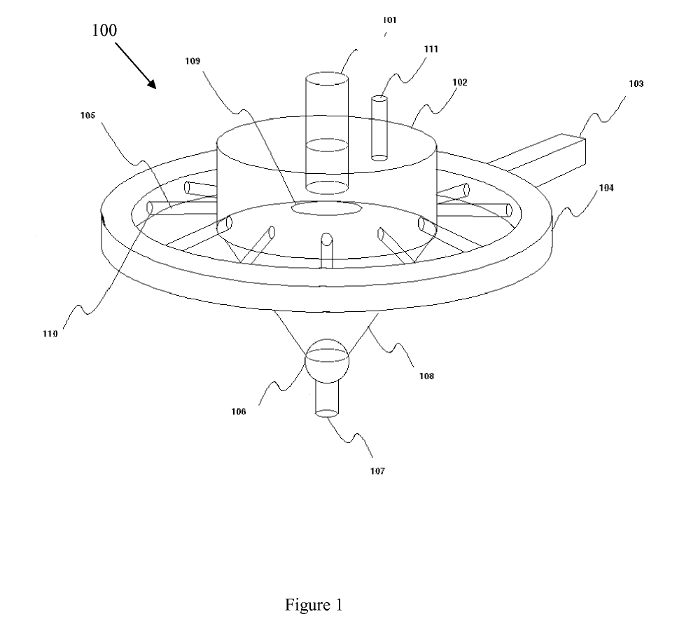

FIG. 1 is a schematic illustration of a reaction vessel in accordance with this invention.

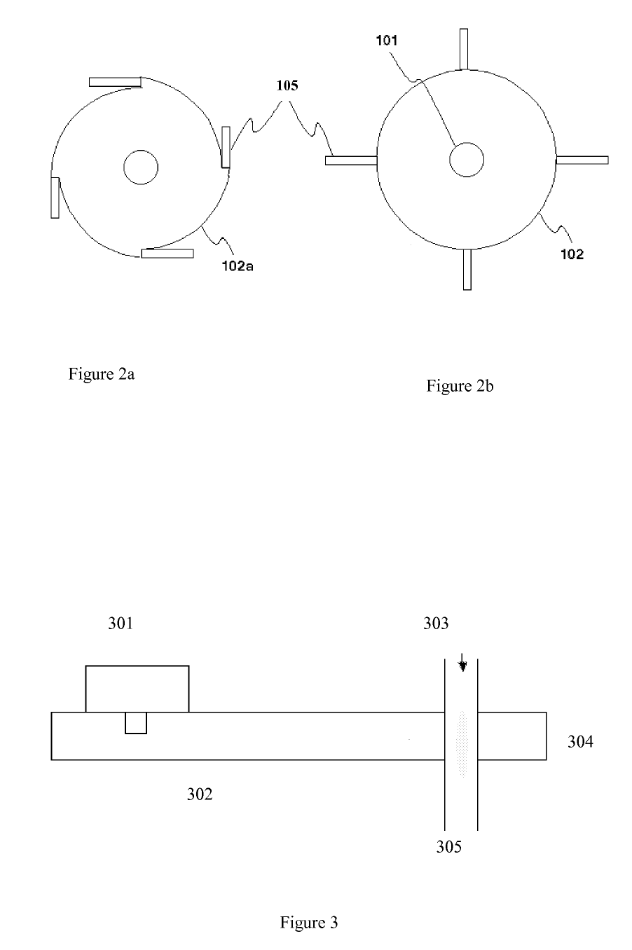

FIG. 2a is a schematic illustration of an embodiment of the invention showing an arrangement of plasma nozzles about the reaction chamber.

FIG. 2b is a schematic illustration of an alternative embodiment showing a different arrangement of plasma nozzles about the reaction chamber.

FIG. 3 illustrates schematically an example of a plasma source that is suitable for incorporation in the nozzles.

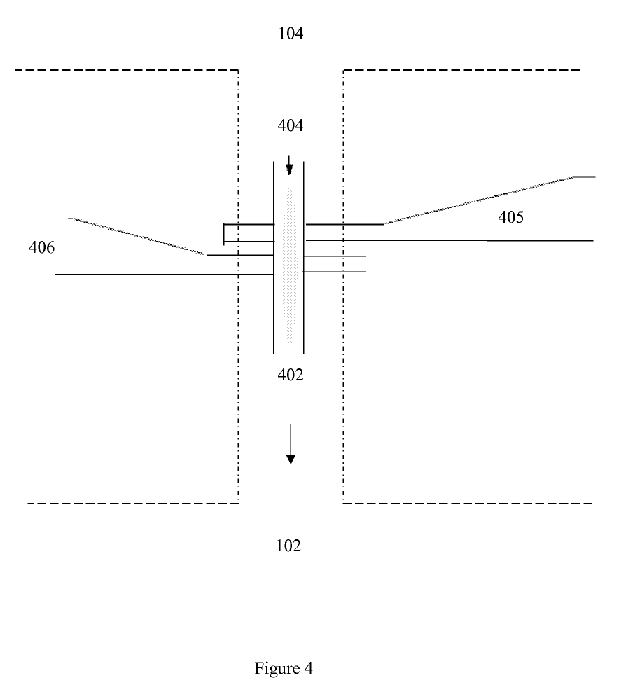

FIG. 4 illustrates schematically a second example of a plasma source that is suitable for use with this invention.

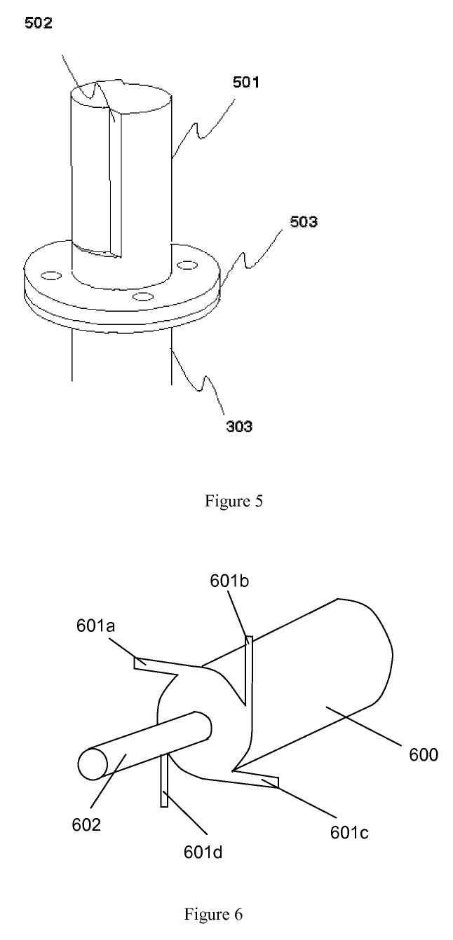

FIG. 5 is a schematic illustration of a component of the plasma nozzle shaped so as to direct feed gases in a vortex motion through the plasma-generating region.

FIG. 6 is a schematic illustration of an alternative component within the plasma nozzle shaped so as to direct feed gases in a vortex motion through the plasma-generating region.

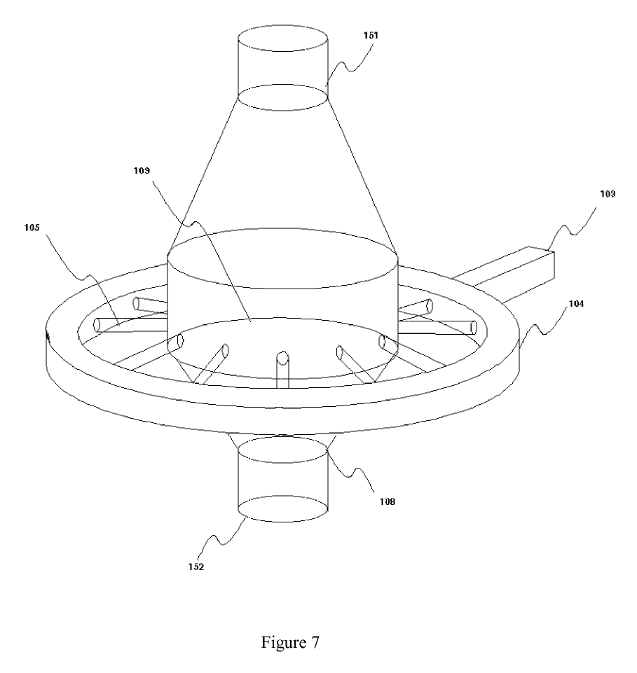

FIG. 7 is a schematic illustration of an alternative embodiment of a reaction vessel, suitable for gas polishing, gas cleaning, hazardous or toxic gas processing.

With reference to FIG. 1 there is shown, in overview, a plasma reactor 100 in accordance with the present invention. The reactor 100 comprises an input channel 103 through which feed gases flow to an annular manifold 104. A plurality of plasma nozzles 105 connects the manifold 104 to a reaction chamber 102. In one specific construction four nozzles of 35 mm diameter are used. A greater or lesser number of nozzles than the number illustrated are also envisaged, as are diameters within the range 25 mm to 50 mm. The reaction chamber 102 is 500 mm diameter but could be for example in the range of 250 mm to several meters, depending on the desired scale of production. Within each plasma nozzle 105 the feed gases may be excited to form a plasma at a plasma-generating zone or region. The minimum separating distance between a plasma-generating zone and the inlet to the reaction chamber is the minimum distance necessary to ensure electromagnetic isolation of the individual microwave fields of the plasma nozzles. The maximum separating distance is dependent upon the persistence of the plasma state which, in turn, is dependent upon at least the energy of the plasma, and the velocity and stabilisation of the feed flow. Preferably, the distance separating the plasma-generating zone from the reaction chamber is between 0.005 m and 1 m, more preferably between 0.05 m and 0.5 m, more preferably still between 0.02 m and 0.2 m.

Each nozzle includes a swirl inducer 110 which is located at the input to the nozzle or between the nozzle input and a plasma generating region (not shown in this figure) of the nozzle. The swirl inducer 110 is adapted to encourage the feed gas to flow with a vortex motion. This vortex motion stabilises the plasma generated within the nozzle in such a way that it is sustained and remains in an ionised state as it flows into the reaction chamber 102. Accordingly, the plasma is reactive for some duration of its time in the reaction chamber 102. Ideally, the direction of rotation of each vortex flow within the nozzles is such that the vortex flow may positively contribute to the general stabilisation of the plasma within the reaction chamber.

A lower chamber 108 is located below the reaction chamber 102 and this may be used in separating reaction products. In this embodiment, it is assumed that a solid product of the reaction is separated in the lower chamber. It is desirable to establish a rotating fluid flow the plane of rotation of which is substantially horizontal to or spiralling within the reaction chamber and so the reaction chamber with the adjoining lower chamber preferably define a cyclone for the collection of solid particles. The solid product passes through a gas restricting valve 106, for example a rotary valve, to a lower output port. An upper output port 101 is provided above the chamber 102 and, in this embodiment of the invention, is used to collect gaseous reaction products, which are prevented from exiting via the lower output port 107 by virtue of the rotary valve 106.

Operation of the plasma reactor 100 will now be described in relation to FIG. 1. A feed supply of gas to be processed enters the manifold 104 through input channel 103 at a controlled pressure, typically between 1 and 2 bar abs. The flow rate of the feed gas is adjusted in accordance with various conditions of the reaction: for example, the energy of the plasma generating source, the chemical composition of the feed gas and the desired reaction outputs. Gas flows are typically between 10 1/min to 100 1/min per nozzle for this embodiment, which used 6 kW magnetrons for plasma generation. The feed gas then flows through the multiple plasma nozzles 105. Within the nozzle, the feed gas is first agitated to a stabilizing flow pattern, such as a vortex motion, by the swirl inducers 110 and then excited to a plasma at the plasma generating region, which is based on 6 kW magnetrons. The result is a moving cloud of dissociated and/or partly dissociated gas, which continues in its flow pattern to the reaction chamber 102. The flow pattern of the plasma increases the stability of the plasma in the sense that the gases are maintained in the plasma state after the plasma generating region and into the reaction chamber 102. Such stabilisation allows the ionised gases to remain concentrated both after the plasma source and within the reaction chamber, thereby extending the active region in which reactions can take place. In the reaction chamber 102, the constituents of the dissociated gas may be separated or may be recombined to form other products, or may react with a substrate or other substance introduced to the chamber 102, depending on the specifics of the required reaction. Whichever reaction route is used, the products are extracted through output ports 101, 107.

The magnetrons in the embodiment described above are 6 kW magnetrons, but alternative magnetron sources of up to 100 kW or even greater still, depending upon availability, could be used. Higher fluid flow rates through the nozzles and in the chamber will be preferred for higher power magnetrons.

A test of the principle underlying the present invention was performed using three microwave plasma nozzles each connected radially to a common 0.5 m diameter reaction chamber and spaced 90° from one another at their intersection with the reaction chamber. Each plasma nozzle comprised a 1.5 kW microwave source which intersected a quartz tube having an internal diameter of 32 mm. The plasma-generating zone of each plasma nozzle was located 0.15 m from the reactor chamber. A buffer gas (nitrogen) was introduced into all three of the plasma nozzles simultaneously and was introduced into the nozzles tangentially thus generating a stabilising swirling gas flow in each of the nozzles. In each of the nozzles the nitrogen was ionised at the plasma-generating zone. The plasma and its afterglow was then observed to extend from the point of generation along the quartz tube and into the reaction chamber.

Separating the plasma generating regions from the reaction chamber has a two-fold effect. First, the plasma output from the nozzles is additive. That is, each nozzle feeds its plasma into the chamber and the volume of plasma in the chamber is multiplied in proportion to the number of nozzles used. Secondly, the reaction chamber is not limited in any way by the method with which plasma is generated, specifically the wavelength of microwaves that are responsible for its generation. This, in turn, means that the design of the plasma reactor is hugely flexible enabling it to be readily adapted to the reaction that is taking place within. For example, a substrate can be introduced to the chamber either directly or via the plasma nozzles or gas flow can be used to entrain specific products.

In other operational modes, different feed materials can be introduced into various of the plasma nozzles around the reaction chamber. This enables the chamber conditions to be set to enable more complex reactions to take place.

The above dimensions and values of parameters used for the reaction vessel are illustrative of one particular embodiment only and are not intended to be limiting. The system described is readily scaled-up. For example, the 6 kW magnetrons operating at 2450 MHz could be replaced by 1 kW to 30 kW magnetrons. Still larger magnetrons that are available of between 35 kW and 100 kW, operating at lower frequency, may be used with larger, upwards of 100 mm diameter, nozzles. The reaction chamber should be scaled up in size in proportion and according to the number of nozzles fitted.

Stabilisation of the plasma is an important feature of the separation as it enables the reactive phase of the feed gas to be maintained in the reaction chamber 102, remote from the plasma-generating source. A vortex motion, which is simply motion of the fluid in a roughly helical pattern, is known to form a relatively stable flow structure. This structure can be readily drawn through the plasma-generating region of the nozzles and the helical motion ensures an even distribution of feed gas exposed to the exciting source. The vortex should persist until such time as the plasma is comfortably within the chamber 102. Obviously the actual time will depend on factors such as vortex velocity and initial gas flow.

In considering stabilisation it is necessary to take account of the balance to be struck between fuelling the reaction that is taking place and forming the plasma. Increasing the flow through the plasma-generating region of the nozzles will transfer plasma faster and this in turn should reduce the need for vortex stabilisation. However, increased flow means increased energy demand on the plasma source in providing energy for the ionisation, in order to avoid reducing the plasma density.

Alternative stabilisation methods are possible of course, although the vortex flow is preferred. It is simply required that an external force is applied to the flow in order to hold the plasma “cloud” in a particular shape, which is maintained as the plasma flows into the reaction chamber 102. For example a magnetic force may be used or a sonic flow.

Within the reaction chamber the plasma cloud extends from the nozzles and then adjacent the chamber wall. This results in extended regions of plasma, spaced alongside the wall, through which feed and other reactant materials flow. This increases residency time of the reactant materials in the plasma zone and so improves process completion and efficiency.

Spacing between the nozzles around the chamber determines the shape and intensity of the plasma cloud(s) within the chamber. In particular, each cloud may merge with its neighbours to produce a continuous toroidal plasma zone located adjacent the wall of the reaction chamber.

In order to illustrate the flexibility of this invention, two specific reactions will be considered. The first reaction is the dissociation of methane to produce hydrogen and carbon. Methane is fed in to the manifold 104 and through the nozzles 105 to enter the reaction chamber 102 as a plasma. From the point that the plasma is generated, the reaction within the plasma to form dissociated carbon and hydrogen begins and continues within the reaction chamber 102. Hydrogen gas is collected through the upper output port 101.

In one embodiment, an electrostatic plate or ring is placed in the lower chamber 108. The solid carbon produced by this reaction is attracted to this plate or ring, on which it is accordingly deposited preferentially. The ring can be removed and replaced, as necessary. The hydrogen can be used as a fuel and the carbon is readily formed into products such as active carbon or carbon black. These carbon products are advantageous in comparison with currently available commercial products in that they are free from sulphur and oxygen impurities.

Alternatively, a combination of methane and water (steam) can be fed into the manifold. In this embodiment, vaporising or steam injection jets are included in the manifold 104 in order to convert the water to gaseous form. The reaction product in this instance is syngas (carbon monoxide and hydrogen). Syngas separation has, in the prior art, proved difficult to achieve. In this embodiment of the invention however, magnesium hydride can be introduced to the lower chamber 108, or as fine particles in a vortex gas flow that extends centrally within the chamber 102 and is drawn out the upper output port 101. The magnesium hydride will absorb hydrogen, leaving the carbon monoxide to be collected out of an additional exit.

With reference now to FIGS. 2a and 2b, alternative orientations of plasma nozzles 105 with respect to the reaction chamber 102 are shown. In FIG. 2a, the arrangement shown is a multiple-start spiral formation 102a. The vortex flow developed within the nozzle is, in this formation 102a, further encouraged in the reaction chamber 102. This can be beneficial for some processes. The alternative arrangement shown in FIG. 2b provides a more axial flow in the reaction chamber 102. This is better suited for syngas formation as opposed to solid carbon formation, using the examples outlined above. It will be understood by one skilled in the art that nozzle configurations between these two extremes form a range of embodiments.

By virtue of the nozzle arrangement, or otherwise, fluid flow within the reaction chamber may be maintained. Under certain circumstances this flow may be sufficient to support a suspended belt of introduced particles, which may act as a substrate for one or more of the reaction products.

The reaction chamber 102 illustrated in this embodiment is toroidal in shape but it can alternatively be in the form of a sphere or cylinder, or other shape, preferably with curved walls.

In the examples of FIGS. 2a and 2b, four plasma nozzles 105 are shown feeding into the reaction chamber 102, but this is for clarity of illustration only. Many more nozzles can be used, the limiting factor essentially being how many can be fitted around the chamber 102. It is also, of course, not essential for all nozzles to be used in generating plasma. For example, in a chamber with ten nozzles, perhaps only five may be used for plasma generation for one particular reaction. The remainder would be closed in order to prevent feed gases bypassing the plasma-generating regions of the active nozzles and entering the chamber. Alternatively nozzles not being used for plasma generation may be used to inject substrate particles or to inject gases (including gases from the output of the reaction chamber) thereby to supply reactants and/or to increase the kinetic energy within the reaction chamber.

As noted above, separation of the plasma generation from the reaction chamber is central to this invention, permitting the nozzles to make an additive contribution to plasma generation. Accordingly, the structure of these nozzles will now be described more fully with reference to FIGS. 3 to 6. FIGS. 3 and 4 illustrate possible arrangements for the plasma-generating region, both based on microwave plasma generation. FIGS. 4 and 5 illustrate examples of the swirl inducers 110.

Turning first to FIG. 3, there is shown a magnetron 301 and waveguide 302 configured as a plasma generator. The magnetron 301 is a conventional microwave generator structure, generally found in microwave ovens. In this arrangement a 1 kW magnetron 301 feeds into a standard waveguide 302 with a closed end 304 forming a quarter wave stub. A quartz tube 303 is located at a point where the E-field is a maximum i.e. one quarter wavelength back from the closed end 304 such that the E-field intensity causes gas contained in the tube 303 to become ionised. Gas to be processed is fed into the tube 303 and flows from the intersection of the tube 303 with the waveguide 302 to an exit 305 in a dissociated state. An example of a suitable waveguide is the Surfaguide™ supplied by Sairem. The quartz tube 303 may equally be of another material that is electrically insulating and with a low dielectric constant at the preferred frequency of operation.

As noted at many places above, the advantage of this invention is that outputs from each plasma generator are added together. This advance is significant. The largest commercially available magnetrons are in the range 75-120 kW. Using a number of such magnetrons, say 10, oriented around a reaction chamber, a plasma zone of MW intensity can be generated.

The fluid passage of each nozzle is preferably straight and the nozzle diameter at the plasma-generating zone is preferably between 5 mm and 100 mm, more preferably between 10 mm and 50 mm, most preferably 30 mm to 40 mm for a 6 kW magnetron.

The microwave plasma generator employed in the plasma nozzle is preferably a coaxial magnetron. Furthermore, the microwaves generated and used in the plasma nozzles preferably have a device wavelength at between 0.01 m and 1 m, more preferably 0.05 m to 0.5 m, most preferably 0.1 m to 0.3 m. Also, the energy supplied to the microwave generator of each plasma nozzle is preferably between 0.1 kW and 500 kW, more preferably 0.5 kW to 120 kW, most preferably 1 kW to 75 kW.

The flow of material through the plasma nozzle preferably includes a fluid, more preferably a gas. Furthermore, the flow through the plasma-generating zone of the plasma nozzle preferentially contains one or more reactants. Preferably, a major part, or ideally all, of at least one of the reactants flows through the plasma-generating zone. The reactants may constitute more than 50% of the flow through the plasma-generating zone, more preferably more than 75% of the flow and most preferably more than 90% of the flow.

The fluid fed to the plasma nozzle is preferably at a temperature of between −20° C. and +600° C., more preferably 0° C. to 200° C., most preferably 50° C. to 150° C. Whereas the pressure within the plasma nozzle is preferably between 0.01 bar abs. to 5 bar abs., more preferably 0.3 bar abs. to 2 bar abs., most preferably 0.8 bar abs. to 1.5 bar abs. The volume of the plasma-generating zone is preferably between 2×10⁻⁶ m³/kW and 10×10⁻⁶m³/kW, more preferably 4×10⁻⁶m³/kW-10×10⁻⁶ m³/kW, most preferably 6×10⁻⁶ m³/kW-10×10⁻⁶ m³/kW. Whereas, the average residence time within the plasma nozzle may be 10⁻⁶ secondsto 10⁻¹ seconds depending upon the material to be ionised.

As an example, the specific energy consumed to completely crack methane passing through the microwave plasma generator of the present invention at 100% efficiency is around 23 kJ/mol.

Whist the volume of the reactor chamber will in each case be dependent upon the intended application and the processing requirements of the plasma reactor, in the case of a 2.45 GHz microwave plasma generator exemplary ranges of volumes are 10⁻³m³ to 10³m³, more preferably 10⁻² m³ to 10² m³, most preferably 1.5 m³ to 10² m³. However, the volume of the reaction chamber is preferably no less than 5×10⁴ m³ per nozzle per KW but may extend upwards from this without limitation.

Furthermore, the residency time within the reaction chamber is dependent upon the reaction(s) occurring within the chamber and the desired output product but may extend from 0.1 seconds to several hours.

The arrangement shown in FIG. 4 represents an improved plasma generator powered by two small magnetrons. The two magnetrons (not shown) are arranged to feed a common quartz tube 404 without interfering with each other or requiring elaborate phase and frequency locking systems. Each plasma nozzle of the reactor shown in FIG. 1 may be of this type, in which case the reactor is capable of generating significantly more power than a reactor employing plasma nozzles of the type shown in FIG. 3.

In FIG. 4 two waveguides 405 and 406 are designed to taper such that the E-field intensifies in the region of the common quartz tube 404. Gas to be processed passes through the quartz tube 404 from the manifold 104 in direction indicated by arrow 402 towards the reaction chamber 102. The gas first passes through a plasma-generating zone produced by waveguide 406 and then through a plasma-generating zone formed by the magnetron waveguide 405. It is preferable for the two plasma-generating zones to be in close proximity so that a single plasma cloud extending between the two plasma generating zones is formed, which is not to say that the waveguides 405, 406 must be antiparallel, as shown in FIG. 4. This orientation is shown for clarity only. With this arrangement, the intensity and the envelope (length) of generated plasma may be increased.

As stated previously, other designs of plasma generator are known in the art and are also suitable for use with this invention. Commercial scale production however is likely to require a high throughput of feed gases and, as such, a plasma generator operating at or above atmospheric pressure is preferred. Microwaves are particularly effective generators of atmospheric plasma for fuel gas processing.

With reference to FIG. 5, there is shown a first design of swirl inducer that is incorporated in the plasma nozzle 105 before the plasma-generating region. If used in combination with the generators shown in FIGS. 3 and 4, the swirl inducer is located in the quartz tube 303, 404 upstream of the plasma-generating regions. The purpose of the swirl inducer is to agitate the feed gas into a stabilising flow such as a vortex flow as it passes through the plasma zone. The swirl inducer includes a number of slits 502 in a protrusion 501. A coupling flange 503, which may be externally cooled, allows for a flexible seal such that the quartz tube 303, 404 is not damaged as it shrinks and remains sealed as it expands, because temperature fluctuations are common during the plasma-generating process. Gas is driven under pressure into the protrusion 501 and forced to exit at the slits 502, which induces a generally helical flow pattern. The seal 503 prevents back flow to the manifold.

An alternative swirl inducer 110 is shown in FIG. 6. This is based on a small version of a Hilsch tube, which is known to induce strong vortex motion in gas flow. Compressed gas is fed in tangentially to a larger diameter tube 600 along arms 601a, b, c, d. Gas exits in a vortex flow both from the larger diameter tube 600 and an adjoining smaller diameter tube 602. Gas from the smaller tube 602 has the stronger vortex flow and is then fed to the plasma-generating region. Gas exiting the larger tube 600 is re-circulated.

Alternative designs of swirl inducers are also envisaged, for example a spiral impeller, a Vortex tube arrangement or a simple fan arrangement. All that is important is that the feed gas is induced into a stabilizing flow before passing through the plasma-generating region of the nozzle. The purpose is two-fold. First, to stabilise the plasma within the quartz tube 303, 404 and so to ensure that it persists into the reaction chamber. Secondly, to ensure that all feed gas passes through the plasma-generating region, which improves the uniformity of its processing.

It can be seen from the above description that many useful applications of a plasma reactor in accordance with this invention exist or may be developed. In particular, embodiments of the invention may be used to dissociate feed gases such as methane, natural gas and biogas with an efficiency not previously known. The dissociated products may be recombined so as to form clean fuels such as hydrogen gas and valued by-products such as high quality carbon black.

A test was conducted using a plasma reactor comprising a single 35 mm diameter plasma nozzle connected radially to a 500 mm diameter reaction chamber at an angle of 20° to the tangent of the reaction chamber. An electrical input of 6.15 kW was supplied to the magnetron of the plasma nozzle through which methane was fed at a rate of 12.8 l/min, at a temperature of 10° C. and a pressure of 20 psig. This produced 1.6×10⁻⁵ m³ volume of plasma, equivalent to the cracking of 1 m³ of methane. Output from the reaction chamber was a quantity of hydrogen and 250 g of carbon which fell under gravity and was collected via a lower port in the reaction chamber.

The invention is adaptable to many scales of operation. Small scale operation lends itself to distributed fuel supplies such as hydrogen filling stations for future transport systems based upon hydrogen as a fuel. Alternatively, the invention could provide small domestic-scale systems that integrate with fuel cells to produce clean, environmentally-sound electricity and water. Large-scale operation lends itself to centralised clean hydrogen production systems.

Still further applications include the processing of toxic and hazardous waste materials, recovering valued elements while destroying the dangerous feed material. An example of a reaction vessel in accordance with this invention that is suitable for such processing is shown in FIG. 7. Elements common to FIG. 1 have been similarly referenced.

The reactor 100 comprises an input channel 103 through which feed gases flow to an annular manifold 104. A plurality of plasma nozzles 105 connects the manifold 104 to a reaction chamber 102. Within each plasma nozzle 105 the feed gases may be excited to form a plasma. Each nozzle includes a vortex inducer (not shown) which is located at the input to the nozzle or between the nozzle input and a plasma generating region (not shown in this figure) of the nozzle. As before, the vortex motion induced in the feed gas stabilises the plasma generated within the nozzle in such a way that it is sustained and remains in an ionised state as it flows into the reaction chamber 102. Accordingly, the plasma is reactive for some duration of its time in the reaction chamber 102. A lower chamber 108 is located below the reaction chamber 102 and this may be used in separating reaction products. An upper output port 151 is provided above the chamber 102 and is used to collect gaseous reaction products and a lower input port 152 is provided below the chamber. The output port 152 is surrounded by a conical skirt that directs gaseous products to this exit. A gas flow disperser (not shown) is located in the centre of the chamber 102 in order to ensure that gas entering through input port 152 passes through the plasma zone at the periphery of the chamber.

Various configurations of gas inputs and outputs are possible, depending on the nature of the process required. Input channel 103 may be fed with the gas to be processed, cleaned or polished. In other processes, this gas is fed through input port 152 and is therefore not dissociated to form a plasma. The plasma may be formed using an inert buffer gas or other reactive gas. Processed gas collected at the output port 151 may be re-fed to the chamber via input channel 103 or input port 152, depending on the process being carried out. This allows multiple cycles of cleaning or processing until the processed gas is reduced to an acceptable level of impurities/hazard/contamination.

The removal of sulphur dioxide (SO₂) from flue gas is an example of a gas cleaning process that may be performed using the plasma reactor of FIG. 7. In overview the process which enables the sulphur dioxide to be removed is as follows:

2SO₂+2H₂O+O₂>2H₂SO₄

Within the plasma reactor described above the dissociation of water and oxygen into a plasma forms hydroxyl radicals and oxygen atoms:

(O₂+e)+(2H₂O+e)>OH+OH+OH+O+O+O +O

The hydroxyl radicals and oxygen atoms then react with the sulphur dioxide to form sulphuric acid which may then be extracted from the flue gas.

Due to the additive nature of the multiple plasma nozzles which enables the plasma reactor of the present invention to be scaled up, it is possible for the plasma reactor to be retrofitted to existing flues and integrated into future flues of commercial scale industries.

Although the plasma reactor has been described principally in relation to the use of microwave plasma-generating sources, it is envisaged that the plasma reactor of the present invention may employ other types of plasma sources in combination with two or more microwave plasma nozzles. An example, of a non-microwave plasma source is as follows: three electrodes arranged in a plane such that they are equidistant from each other with a plasma-generating zone lying in the plane of the three electrodes and equidistant therefrom. An electrically insulated tube of a suitable inert material, such as a ceramic, is arranged along an axis at 90 degrees to the plane of the three electrodes and intersecting that plane. The tube is used to contain a gas flow that flows across the plasma-generating zone. A high voltage DC, AC (which may be 3 phase supply) or pulsed DC is applied to the electrodes such that an arc is discharged between the electrodes passing through apertures in the tube and thus across the plasma-generating zone. The arc ionises the gas flowing across the plasma-generating zone between the electrodes, producing a plasma.

The voltage applied to the electrodes must exceed the breakdown voltage of the gas flowing between the electrodes and the current may be limited by current control circuitry such that the power transferred into the plasma is controlled according to the desired reaction. When the supply is either AC or DC the plasma is predominantly thermal, however when pulsed DC is used, a degree of non-equilibrium plasma is also produced. It will, of course, be apparent that the plasma generated may be stabilized using the same or similar techniques to those described above.

Changes to the plasma reactor other than those described above are envisaged without departing from the spirit and scope of the invention as defined in the claims appended hereto. Furthermore, it will be immediately apparent that processes other than those described above may additionally be performed using the plasma reactor of this invention.

1.-35. (canceled)

36. A reaction vessel comprising:
a reaction chamber; and
two or more plasma nozzles coupled to the reactor chamber,
wherein each plasma nozzle comprises:
a microwave plasma generator powered by a magnetron, and
a feed tube for directing a flow of material via the plasma generator to a respective inlet to the reaction chamber whereby the plasma generator at least partly ionises the material to form a plasma prior to entry of the at least partly ionised material into the reaction chamber, and
wherein the plasma-generating region of each nozzle is separated from the reactor chamber at a distance between 0.005 to 1 m.

37. The reaction vessel according to claim 36, wherein the one or more plasma nozzles are adapted to encourage stabilising flow by shaping of the feed tube therein.

38. The reaction vessel according to either of claim 37, wherein the one or more plasma nozzles are adapted to encourage stabilising flow by incorporation of an agitating element within the feed tube.

39. The reaction vessel according to claim 37, wherein the plasma stabilising flow is a vortex.

40. The reaction vessel according to claim 36, further comprising a single nozzle wherein at least a section of the feed tube of the nozzle is tapered inwardly towards the inlet to the reaction chamber.

41. The reaction vessel according to claim 40, wherein the nozzle and its inlet to the reaction chamber are coaxially aligned with the reaction chamber whereby an additional stabilising flow is established within the reaction chamber, and wherein the additional stabilising flow is a vortex.

42. The reaction vessel according to claim 41, wherein the additional stabilising flow may support particulates in fluid suspension within the reaction chamber.

43. The A reaction vessel according to claim 42, wherein the reaction chamber is non-resonant with respect to the plasma generator.

44. The reaction vessel according to claim 36, wherein the reaction chamber includes an exit channel that extends through the wall of the chamber into the chamber.

45. The reaction vessel according to claim 36,
wherein the vessel includes a secondary chamber with exit port and gas restrictive valve in fluid communication with the reaction chamber, and
wherein the secondary chamber includes an exit port.

46. The reaction vessel according to claim 45, wherein the secondary chamber includes an electrostatic collector, powder precipitator or polymer-forming substrate.

47. The reaction vessel according to claim 36,
wherein the reaction chamber includes an input channel, and
wherein a secondary flow of one or more reactants may be passed along the input channel.

48. The reaction vessel according to claim 36, wherein the vessel includes an atomising or vaporising device prior to the plasma generator for atomising or vaporising the feed material.

49. The reaction vessel according to claim 36, wherein the vessel includes an atomising or vaporising device for atomising or vaporising one or more reactants.

50. A plasma nozzle for feeding plasma to a reactor chamber comprising:
a plasma generator;
a feed tube for directing a flow of material from an inlet via the plasma generator; and
a nozzle outlet remote from the plasma generator,
wherein the nozzle outlet is adapted to couple to a reaction chamber whereby the plasma generator at least partly ionises the material to form a plasma which is sustained to flow through the nozzle outlet by employing a magnetron as microwave source comprising at least one waveguide dimensioned for microwave radiation intersecting the feed tube at or near a position at which the electric field of the microwave radiation is most intense,
wherein the plasma-generating region of each nozzle is separated from the reactor chamber at a distance between 0.005 to 1 m, and
wherein the nozzle includes two plasma generators, each with a respective plasma-generating region, arranged such that the feed tube intersects both plasma-generating regions.

51. The plasma nozzle according to claim 50, wherein the spacing between the respective intersections of the two plasma-generating regions with the feed tube is selected so that a single plasma cloud is formed within the feed tube extending between the two intersections.

52. A hydrogen generating vessel comprising:
a means for connecting to a supply of a gaseous hydrocarbon;
at least two plasma nozzles coupled to the means for connecting; and
a reaction chamber coupled to the at least two plasma nozzles,
wherein each plasma nozzle comprises:
a microwave plasma generator powered by a magnetron, and
a feed tube for directing a flow of the hydrocarbon via the plasma generator to a respective inlet to the reaction chamber whereby the plasma generator at least partly ionises the gaseous hydrocarbon to form a plasma prior to entry of the at least partly ionised hydrocarbon into the reaction chamber,
wherein the reaction chamber includes at least one outlet via which hydrogen is collected, and
wherein the plasma-generating region of each nozzle is separated from the reactor chamber space at a distance between 0.005 to 1 m.

53. A carbon extraction vessel comprising:
a means for connecting to a supply of a gaseous hydrocarbon;
at least two plasma nozzles coupled to the means for connecting; and
a reaction chamber coupled to the at least two plasma nozzles,
wherein each plasma nozzle comprises:
a microwave plasma generator powered by a magnetron, and
a feed tube for directing a flow of the hydrocarbon via the plasma generator to a respective inlet to the reaction chamber whereby the plasma generator at least partly ionises the gaseous hydrocarbon to form a plasma prior to entry of the at least partly ionised hydrocarbon into the reaction chamber,
wherein the reaction chamber includes at least one outlet via which the carbon is collected,
wherein the plasma-generating region of each nozzle is separated from the reactor chamber space at a distance between 0.005 to 1 m,
wherein the manner of collection of the carbon determines the predominant form of carbon collected, and
wherein the reaction chamber includes a substrate onto which carbon is preferentially deposited, the carbon being collected by removal of the substrate from the reaction chamber.

54. The reaction vessel according to claim 36, wherein the plasma-generating region of each nozzle is separated from the reactor chamber at a distance between 0.05 and 0.5 m.

55. The reaction vessel according to claim 36, wherein the plasma-generating region of each nozzle is separated from the reactor chamber at a distance between 0.02 and 0.2 m.
